(19) United States
(12) Patent Application Publication
(10) Pub. No.: US 2009/0100457 A1
(43) Pub. Date: Apr. 16, 2009

(54) Apparatus and method for managing customized channel in IP-based broadcasting services

(75) Inventors: Sung Yong Lee, Kangwon-do (KR); Sim-Kwon Yoon, Gwangjoo-city (KR); Ho Young Song, Daejeon-city (KR); Bong Tae Kim, Daejeon-city (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Electronics and Telecommunications Research Institute

(21) Appl. No.: 12/156,906

(22) Filed: Jun. 4, 2008

(30) Foreign Application Priority Data
Oct. 10, 2007 (KR) 10-2007-0102135

(51) Int. Cl. H04N 7/16

(52) U.S. Cl. 725/28

(57) ABSTRACT

Provided are an apparatus and method for managing customized channels in Internet Protocol (IP)-based broadcasting services. The apparatus includes: a monitored channel selection message receiver receiving a monitored channel selection message from a group manager of a viewing group consisting of customized channels that provide broadcast programs in real time according to a broadcast program list set by each viewer, wherein the monitored channel selection message contains information about a channel selected to be monitored by the group manager among the customized channels in the viewing group; a monitored channel provider transmitting a broadcast program being provided in real time over the channel selected to be monitored to the group manager; and a harmful channel blocking unit forcedly terminating the transmission of the broadcast program over the monitored channel upon receipt of a harm determination message notifying that the broadcast program being provided over the monitored channel is harmful from the group manager. The apparatus and method allow easy management of customized channels by blocking broadcast programs harmful to viewers over customized channels and providing the viewers with broadcast programs according to a preset schedule.

### CROSS-REFERENCE TO RELATED PATENT APPLICATION

This application claims the benefit of Korean Patent Application No. 10-2007-0102135, filed on Oct. 10, 2007, in the Korean Intellectual Property Office, the disclosure of which is incorporated herein in its entirety by reference.

### BACKGROUND OF THE INVENTION

1. Field of the Invention

The present invention relates to an apparatus and method for managing customized channels in Internet Protocol (IP)-based broadcasting services, and more particularly, to an apparatus and method for easily managing customized channels capable of providing viewers with broadcasting services according to a preset schedule by blocking a channel providing harmful broadcasting programs when providing multi-channel services over an IP-based broadcast network to meet increased demand for customized channel services.

2. Description of the Related Art

Conventional approaches related to customized channel services in IP-based broadcasting mostly focus on providing IP-based customized channel services.

Korean Patent Laid-open Application No. 2006-0070298 (laid open on Jun. 23, 2006) presents the configuration of a customized real-time Internet broadcast system for providing customized broadcasting services that allow viewers to watch a group of their favorite content selected from various IP-based broadcast content available. However, the above-cited reference describes only the structure of a customized channel service system capable of providing viewer's preference channels selected among a multitude of channels via the Internet.

With increasing popularity of the customized services, the number of channels personalized to each user may increase exponentially. Thus, there is an urgent need to develop a method for managing IP-based customized channel services in a multi-channel environment.

### SUMMARY OF THE INVENTION

The present invention provides an apparatus and method for managing customized channels in IP-based broadcasting services that allow a group manager to directly monitor and manage broadcast programs provided over channels designated by each viewer, thereby blocking harmful program content.

The present invention also provides an apparatus and method for managing customized channels in IP-based broadcasting services that enables insertion of a special or emergency broadcast program other than a normal program from a schedule designated by each viewer in an emergency situation.

The objects and advantages of the invention may be realized and attained by means of methods and devices described in the appended claims.

According to an aspect of the present invention, there is provided an apparatus for managing customized channels including: a monitored channel selection message receiver receiving a monitored channel selection message from a group manager of a viewing group consisting of customized channels that provide broadcast programs in real time according to a broadcast program list set by each viewer, wherein the monitored channel selection message contains information about a channel selected to be monitored by the group manager among the customized channels in the viewing group; a monitored channel provider transmitting a broadcast program being provided in real time over the channel selected to be monitored to the group manager; and a harmful channel blocking unit forcedly terminating the transmission of the broadcast program over the monitored channel upon receipt of a harm determination message notifying that the broadcast program being provided over the monitored channel is harmful from the group manager.

According to another aspect of the present invention, there is provided a method for managing customized channels, including: receiving a monitored channel selection message from a group manager of a viewing group consisting of customized channels that provide broadcast programs in real time according to a broadcast program list set by each viewer, wherein the monitored channel selection message contains information about a channel selected to be monitored by the group manager among the customized channels in the viewing group; transmitting a broadcast program being provided in real time over the channel selected to be monitored to the group manager; and forcedly terminating the transmission of the broadcast program over the monitored channel upon receipt of a harm determination message notifying that the broadcast program being provided over the monitored channel is harmful from the group manager.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a configuration of an Internet Protocol (IP)-based broadcasting system for providing customized channel services according to an embodiment of the present invention;

FIG. 2 illustrates a configuration of an apparatus for managing customized channels in IP-based broadcasting services;

FIG. 3 illustrates a procedure for creating a new viewing group and registering a manager of the new viewing group in an apparatus for managing customized channels according to an embodiment of the present invention;

FIG. 4 illustrates a procedure for each viewer's registering his/her customized channel with a specific viewing group in an apparatus for managing customized channels according to an embodiment of the present invention;

FIG. 5 illustrates a procedure for a group manager's determining whether a broadcast program being provided on a customized channel belonging to a viewing group that he/she manages is harmful and forcedly terminating transmission of the broadcast program in an apparatus for managing customized channels according to an embodiment of the present invention;

FIG. 6 illustrates a procedure for transmitting a special or emergency broadcast program notifying an emergency situation to a viewer instead of a program from a program list set by the viewer in an apparatus for managing customized channels according to an embodiment of the present invention;

FIG. 7 illustrates an example of a Graphic User Interface (GUI) screen for both a broadcast viewer and a group manager according to an embodiment of the present invention; and

FIG. 8 is a flowchart illustrating a method for managing customized channels according to an embodiment of the present invention.

### DETAILED DESCRIPTION OF THE INVENTION

It should be noted that the following description is made to illustrate the general principles of the present invention. It will be understood that those skilled in the art will be able to devise various other arrangements, which, although not explicitly described or shown herein, embody the principles of the invention and are included within its concept and scope.

In addition, all examples and conditional language stated herein are principally intended expressly to only aid in understanding the principles of the invention and should not be construed to limit the present invention. Furthermore, all statements contained herein regarding principles, aspects, and embodiments of the invention, as well as the detailed description thereof, are intended to encompass both structural and functional equivalents thereof. It should also be understood that such equivalents include both currently known equivalents as well as equivalents that will be developed in the future, i.e., any elements developed to perform the same function regardless of structure.

The functions of various elements shown in the drawing including functional blocks described as a processor or other similar devices may be provided through the use of dedicated hardware as well as hardware capable of executing software in association with appropriate software. When provided by a processor, the functions may be provided by a single dedicated processor, a single shared processor, or a plurality of individual processors, some of which may be shared. Further, explicit use of the term “processor”, “controller”, or terms having similar meanings should not be construed to refer exclusively to hardware capable of executing software, and may implicitly include, without limitation, digital signal processor (DSP) hardware, read-only memory (ROM), RAM, and non-volatile memories for storing software. Other known and commonly used hardware can be included therein.

Detailed description of well-known functions and constructions incorporated herein may be omitted to avoid obscuring the subject matter of the present invention. The present invention will now be described more fully with reference to the accompanying drawings, in which exemplary embodiments of the invention are shown.

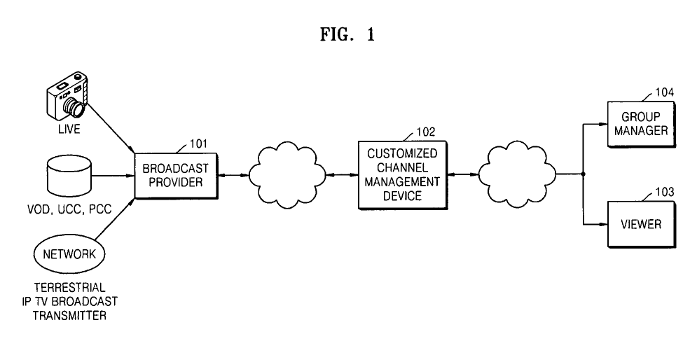

FIG. 1 illustrates a configuration of an Internet Protocol (IP)-based broadcasting system for providing customized channel services according to an embodiment of the present invention;

Referring to FIG. 1, the IP-based broadcasting system according to the present embodiment includes a broadcast provider 101, a customized channel management device 102, a viewer 103, and a group manager 104.

The broadcast provider 101 transmits via the Internet content stored therein, live broadcast content and other content received from another party. The customized channel management device 102 receives broadcast programs from the broadcast provider 101 and provides the broadcast programs in real time according to a program list set by the viewer 103. In this way, a service designed to provide broadcast programs in real time according to a program list designated by each viewer is referred to as a “customized channel service”.

The viewer 103 receives broadcast content delivered over the Internet from the customized channel management device 102 for viewing. The viewer 103 is registered in a specific viewing group. The group manager 104 randomly selects one of broadcast programs being provided via a channel customized to the viewer 103, which belongs to a viewing group that he/she manages, for viewing, and monitors and manages whether the selected broadcast program is harmful to the viewer 103.

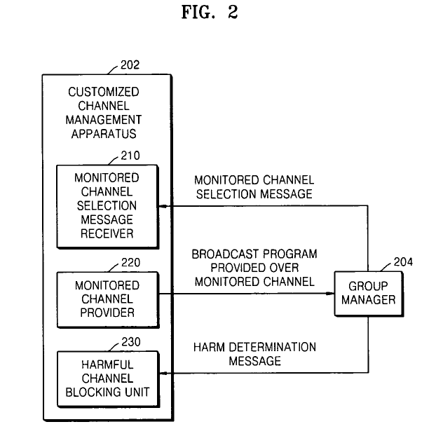

FIG. 2 illustrates a configuration of an apparatus 202 for managing customized channels in IP-based broadcasting services (“customized channel management apparatus”).

Referring to FIG. 2, the customized channel management apparatus 202 according to the present embodiment includes a monitored channel selection message receiver 210, a monitored channel provider 220, and a harmful channel blocking unit 230.

The monitored channel selection message receiver 210 receives a monitored channel selection message from a group manager 204 of a viewing group consisting of customized channels that provide broadcast programs in real time according to a broadcast program list set by each viewer. The monitored channel selection message contains information about a channel selected to be monitored by the group manager 204 among the customized channels in the viewing group.

The group manager 204 monitors broadcast programs being provided via customized channels belonging to the viewing group that he/she manages. The group manager 204 also selects a customized channel to be monitored at random and transmits a monitored channel selection message to the customized channel management apparatus 202.

The monitored channel provider 220 transmits a broadcast program being provided in real time over the channel selected to be monitored by the group manager 204 to the group manager 204 in response to the monitored channel selection message received by the monitored channel selection message receiver 210.

If the group manager 204 determines that the received broadcast program is harmful to a viewer of the customized channel, it transmits a message notifying that the broadcast program being provided over the monitored channel is harmful (“harm determination message”) so as to block the broadcast program that is harmful to the viewer. Upon receipt of a harm determination message from the group manager 204, the harmful channel blocking unit 230 forcedly terminates the transmission of the broadcast program over the monitored channel.

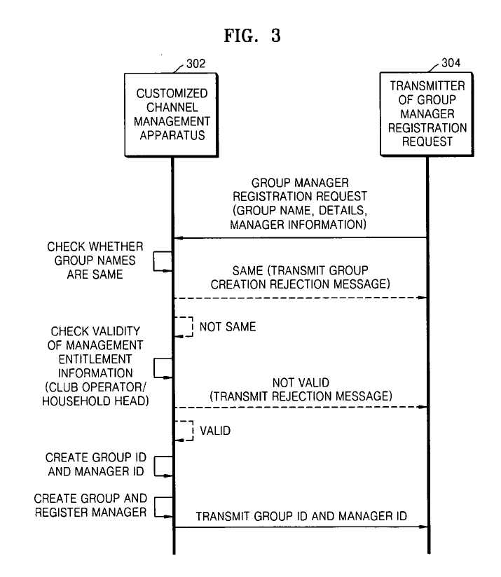

FIG. 3 illustrates a procedure for creating a new viewing group and registering a manager of the new viewing group in a customized channel management apparatus 302 according to an embodiment of the present invention. Referring to FIG. 3, a group manager registration request receiver in the customized channel management apparatus 302 receives a group manager registration request for creating a viewing group and registering a group manager. Upon verifying mandatory information needed for registration as a group manager, which is contained in the received group manager registration request, a group manager registration unit thereof creates a new viewing group and registers a transmitter 304 of the group manager registration request as a group manager of the newly created viewing group. In this case, a group ID creator thereof creates and stores group ID and manager ID that respectively identify the viewing group and the group manager and a group ID transmitter thereof transmits the group ID and manager ID to the group manager.

The group manager registration request may further include the name of a new viewing group to be created. If the name of the new viewing group is the same as the previously stored viewing group name, the group manager registration unit does not create the new viewing group but transmits a message notifying that it has not created the new viewing group to the transmitter of the group manager registration request.

The group manger may be the head of a household, club operator, private broadcasting operator, or in-house broadcasting manager. In the present embodiment, the group manager registration request may also contain manager entitlement information that verifies the group manager is entitled to directly monitor and manage customized channels belonging to a viewing group that he/she manages. Further, the procedure may include checking the validity of the manager entitlement information.

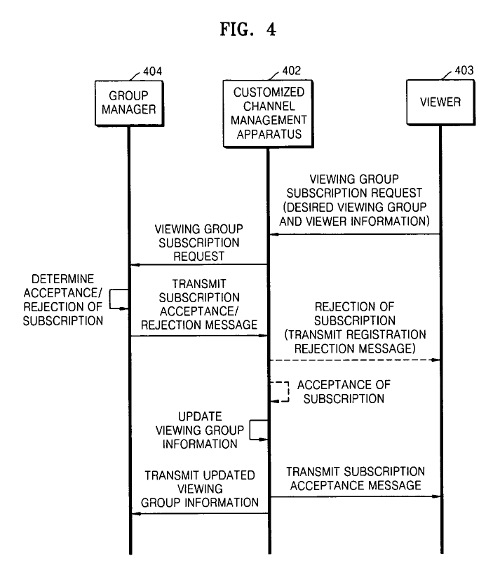

FIG. 4 illustrates a procedure for each viewer's registering his/her customized channel with a specific viewing group in a customized channel management apparatus 402 according to an embodiment of the present invention.

Referring to FIG. 4, to achieve registration of a viewer's customized channel with a specific viewing group for management by a group manager 404, the viewer 403 designates a desired viewing group and transmits it with his/her personal information to the customized channel management apparatus 402 for acceptance by the group manager 404.

That is, the viewer 403 that has not belonged to a viewing group transmits a viewing group subscription request containing information about a desired viewing group and his or her personal information to the customized channel management apparatus 402. A viewing group subscription request receiver thereof receives the viewing group subscription request and a viewing group subscription request transmitter thereof then transmits it to the group manager 404 of the desired viewing group.

The group manager 404 checks the viewer's information contained in the viewing group subscription request and transmits a subscription acceptance message accepting the viewing group subscription request to the customized channel management apparatus 402.

Upon receipt of the subscription acceptance message, a viewing group information updating unit thereof adds the viewer 403 that has transmitted the viewing group subscription request and a customized channel allocated to the viewer 403 to the information about the desired viewing group. A viewing group information transmitter thereof then transmits the updated viewing group information to the group manager 404 of the viewing group.

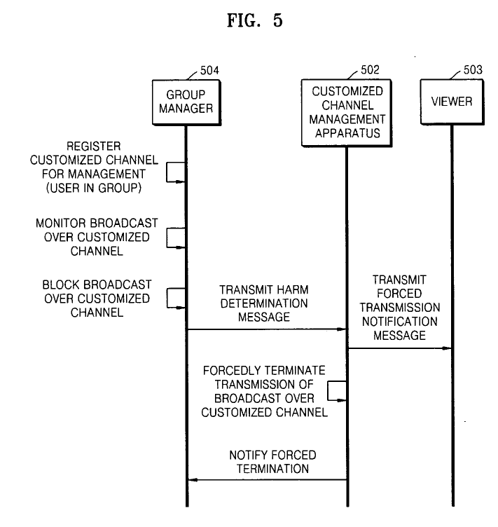

FIG. 5 illustrates a procedure for a group manager's determining whether a broadcast program being provided over a customized channel belonging to a viewing group that he/she manages is harmful and forcedly terminating transmission of the broadcast program in a customized channel management apparatus 502 according to an embodiment of the present invention.

Referring to FIG. 5, if a group manager 504 that has monitored broadcast programs being provided over customized channels belonging to a viewing group that he/she manages needs to block transmission of a broadcast program over a specific customized channel, the group manager 504 transmits a harm determination message containing information about the specific customized channel to the customized channel management apparatus 502.

The customized channel management apparatus 502 transmits a forced termination notification message that notifies that the transmission of a broadcast program has been forcedly terminated to a viewer 503 of the customized channel contained in the received harm determination message and forcedly terminates the transmission of the broadcast program over the specific customized channel.

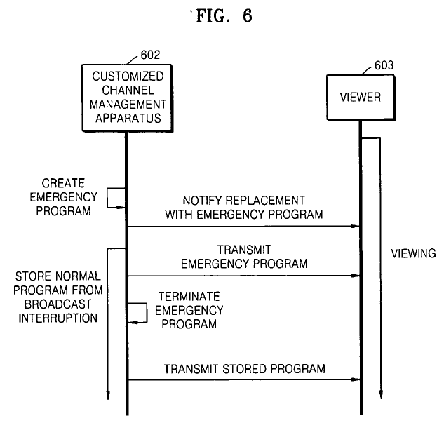

FIG. 6 illustrates a procedure for transmitting a special or emergency broadcast program notifying an emergency situation to a viewer 603 instead of a program in a program list set by the viewer 603 in a customized channel management apparatus 602 according to an embodiment of the present invention.

Referring to FIG. 6, when an emergency situation occurs, the customized channel management apparatus 602 transmits an emergency broadcast notification message, which informs replacement of a normal program with a special or emergency program, to the viewer 603 and then immediately delivers the special or emergency program over a customized channel of the viewer 603. The customized channel management apparatus 602 simultaneously stores the unbroadcast part of the interrupted normal program in a separate storage space. Upon completion of transmitting the special or emergency program, the customized channel management apparatus 602 resumes the transmission of the stored unbroadcast part of the program over the customized channel of the viewer 603.

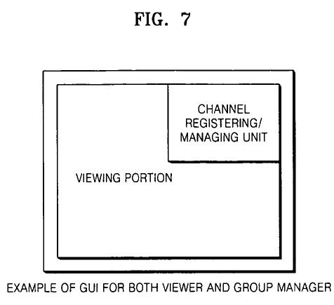

FIG. 7 illustrates an example of a Graphic User Interface (GUI) screen for both a viewer and a group manager according to an embodiment of the present invention.

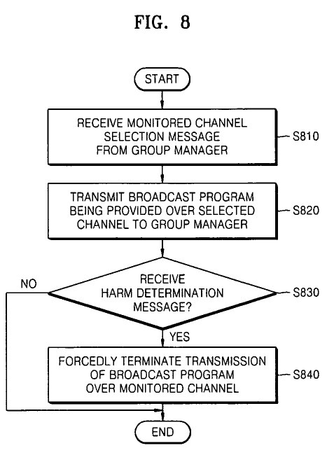

In the present invention, respective GUIs may be provided for a broadcast provider, a viewer, and a group manager. FIG. 8 shows an example in which a GUI for a group manager is integrated with a GUI for a viewer, which means that the viewer may be the group manager.

FIG. 8 is a flowchart illustrating a method for managing customized channels according to an embodiment of the present invention.

Referring to FIG. 8, the method includes steps that are performed in a time series by the customized channel management apparatus 202 shown in FIG. 2. The forgoing description of the customized channel management apparatus 202 also applies to the method according to the present embodiment.

First, the customized channel management apparatus 202 receives a monitored channel selection message from a group manager of a viewing group consisting of customized channels that provide broadcast programs in real time according to a broadcast program list set by each viewer (S810). The monitored channel selection message contains information about a channel selected to be monitored by the group manager among the customized channels in the viewing group.

Thereafter, the customized channel management apparatus 202 transmits a broadcast program being provided in real time over the channel selected to be monitored by the group manager to the group manager, in response to the monitored channel selection message received at step S810 (S820).

When receiving a harm determination message notifying that the broadcast program being provided over the monitored channel is harmful from the group manager (S830), the customized channel management apparatus 202 forcedly terminates the transmission of the broadcast program over the monitored channel (S840).

The invention can also be embodied as computer readable codes on a computer readable recording medium. The computer readable recording medium is any data storage device that can store data which can be thereafter read by a computer system. Examples of the computer readable recording medium include ROM, RAM, CD-ROMs, magnetic tapes, floppy disks, flash memories, optical data storage devices, and carrier waves (such as data transmission through the Internet). The computer readable recording medium can also be distributed over network coupled computer systems so that the computer readable code is stored and executed in a distributed fashion. Further, the format of font data stored in a font ROM can be embodied as computer readable codes on ROM, RAM, CD-ROMs, magnetic tapes, floppy disks, flash memories, optical data storage devices, and other computer readable recording media.

While the present invention has been particularly shown and described with reference to exemplary embodiments thereof, the description of the embodiments is to be construed as exemplary only and does not describe every possible instance of the invention. Therefore, it should be understood by those of ordinary skill in the art that various changes, modifications, and adaptations in form and details may be made therein without departing from the spirit and scope of the present invention as defined by the following claims.

As described above, the present invention provides a customized channel management apparatus and method that allow easy management of customized channels by blocking broadcast programs harmful to viewers over customized channels and easily providing the viewers with broadcast programs according to a preset schedule. The present invention also allows monitoring of broadcast programs and flexible broadcasting, thereby suppressing an increase in indecent, harmful broadcasting content that may occur in customized channel services.

What is claimed is:

1. An apparatus for managing customized channels, comprising
a monitored channel selection message receiver receiving a monitored channel selection message from a group manager of a viewing group consisting of customized channels that provide broadcast programs in real time according to a broadcast program list set by each viewer, wherein the monitored channel selection message contains information about a channel selected to be monitored by the group manager among the customized channels in the viewing group;
a monitored channel provider transmitting a broadcast program being provided in real time over the channel selected to be monitored to the group manager; and
a harmful channel blocking unit forcedly terminating the transmission of the broadcast program over the monitored channel upon receipt of a harm determination message notifying that the broadcast program being provided over the monitored channel is harmful from the group manager.

2. The apparatus of claim 1, further comprising:
a group manager registration request receiver receiving a group manager registration request that contains manager entitlement information verifying that the group manager is entitled to monitor customized channels; and
a group manager registration unit creating a new viewing group and registering a transmitter of the group manager registration request as a group manager of the newly created viewing group if the manager entitlement information is valid.

3. The apparatus of claim 2, wherein the group manager registration request further includes the name of the new viewing group and
wherein if the name of the new viewing group is the same as previously stored viewing group name, the group manager registration unit does not create the new viewing group but transmits a message notifying that it has not created the new viewing group to the transmitter of the group manager registration request.

4. The apparatus of claim 2, wherein the group manager registration unit comprises:
a group ID creator creating and storing group ID and manager ID that respectively identify the new viewing group and the transmitter of the group manager registration request; and
a group ID transmitter transmitting the group ID and the manager ID to the group manager.

5. The apparatus of claim 1, further comprising:
a viewing group subscription request receiver receiving the viewing group subscription request containing information about a desired viewing group and viewer's information from the viewer who has not belonged to the viewing group;
a viewing group subscription request transmitter transmitting the viewing group subscription request to a group manager of the desired viewing group; and
a viewing group information updating unit adding, upon receipt of a subscription acceptance message accepting the viewing group subscription request from the group manager of the desired viewing group, the viewer that has transmitted the viewing group subscription request and a customized channel allocated to the viewer to the information about the desired viewing group.

6. The apparatus of claim 5, further comprising a viewing group information transmitter transmitting the updated information about the viewing group to the group manager of the viewing group.

7. The apparatus of claim 1, wherein if the viewing group consists of channels customized for members of a specific family, the group manager of the viewing group is the head of the family.

8. The apparatus of claim 2, wherein if the viewing group includes channels customized for members of a specific club, the group manger of the viewing group is an operator of the club.

9. A method for managing customized channels, comprising:
receiving a monitored channel selection message from a group manager of a viewing group consisting of customized channels that provide broadcast programs in real time according to a broadcast program list set by each viewer, wherein the monitored channel selection message contains information about a channel selected to be monitored by the group manager among the customized channels in the viewing group;
transmitting a broadcast program being provided in real time over the channel selected to be monitored to the group manager; and
forcedly terminating the transmission of the broadcast program over the monitored channel upon receipt of a harm determination message notifying that the broadcast program being provided over the monitored channel is harmful from the group manager.

10. The method of claim 9, further comprising:
receiving a group manager registration request that contains manager entitlement information verifying that the group manager is entitled to monitor customized channels; and
creating a new viewing group and registering a transmitter of the group manager registration request as a group manager of the newly created viewing group if the manager entitlement information is valid.

11. The method of claim 10, wherein the group manager registration request further includes the name of the new viewing group and
Wherein the registering of the transmitter of the group manager registration request as the group manager comprises, if the name of the new viewing group is the same as previously stored viewing group name, transmitting a message notifying that the new viewing group is not created to the transmitter of the group manager registration request instead of creating the new viewing group.

12. The method of claim 10, wherein the registering of the transmitter of the group manager registration request as the group manager further comprises:
creating and storing group ID and manager ID that respectively identify the new viewing group and the transmitter of the group manager registration request; and
transmitting the group ID and the manager ID to the group manager.

13. The method of claim 9, further comprising:
receiving the viewing group subscription request containing information about a desired viewing group and viewer's information from the viewer who has not belonged to the viewing group;
transmitting the viewing group subscription request to a group manager of the desired viewing group; and
adding, upon receipt of a subscription acceptance message accepting the viewing group subscription request from the group manager of the desired viewing group, the viewer that has transmitted the viewing group subscription request and a customized channel allocated to the viewer-to the information about the desired viewing group.

14. The method of claim 13, further comprising transmitting the updated information about the viewing group to the group manager of the viewing group.

15. The method of claim 9, wherein if the viewing group consists of channels customized for members of a specific family, the group manager of the viewing group is the head of the family.

16. The method of claim 9, wherein if the viewing group includes channels customized for members of a specific club, the group manger of the viewing group is an operator of the club.
